(19) United States
(12) Patent Application Publication
(10) Pub. No.: US 2001/0042082 A1
(43) Pub. Date: Nov. 15, 2001

(54) Information processing apparatus and method

(76) Inventors: Toshiaki Ueguri, Kanagawa (JP); Takaya Ueda, Kanagawa (JP); Takashi Aso, Kanagawa (JP); Makoto Hirota, Kanagawa (JP)

Correspondence Address: FITZPATRICK CELLA HARPER & SCINTO, 30 ROCKEFELLER PLAZA, NEW YORK, NY, 10112, US

(21) Appl. No.: 09/832,952

(22) Filed: Apr. 12, 2001

(30) Foreign Application Priority Data
Apr. 13, 2000 (JP) 112412/2000
Apr. 11, 2001 (JP) 112656/2001

(51) Int. Cl. G06F 17/24; G06F 17/30

(52) U.S. Cl. 707/513; 707/531; 707/511; 707/203

(57) ABSTRACT

A server acquires a web page corresponding to the URL that a client registers, and detects new text (to be referred to as new information hereinafter) inserted in that web page. The server converts the detected new information into one of a character string, phonetic character string, and synthetic speech, and delivers it to the client. The client receives the new information delivered from the server, converts it into synthetic speech, and outputs the synthetic speech.

### FIELD OF THE INVENTION

The present invention relates to an information processing apparatus and method suitable for a system for converting text inserted in a web page into speech, and providing that speech to the user.

### BACKGROUND OF THE INVENTION

In recent years, text-to-speech synthesis techniques have been used in various technical fields. Recently, a text-to-speech synthesis system that converts text inserted in a web page into speech, and provides that speech to the user has been proposed.

However, since most of recently proposed text-to-speech synthesis systems convert text inserted in a web page into speech from the beginning to the end, if the text size is large, the load on the user becomes heavy.

In a recent text-to-speech synthesis system, the user cannot determine the latest information inserted in a web page or misses information he or she wants to know unless he or she sets his or her mind to listening to the speech from the beginning to the end, resulting in inconvenience.

### SUMMARY OF THE INVENTION

An object of the present invention is to solve the above-described problem.

To achieve the above object, an information processing apparatus according to one preferred embodiment of the present invention comprises detection means for detecting new text inserted in a web page, and transmission means for transmitting a character string that represents the text to a client which registered the web page.

An information processing method according to another embodiment of the present invention comprises a detection step of detecting new text inserted in a web page, and a transmission step of transmitting a character string that represents the text to a client which registered the web page.

An information processing method according to still another embodiment of the present invention comprises detection means for detecting new text inserted in a web page, conversion means for converting a character string that represents the text into a phonetic character string, and transmission means for transmitting the phonetic character string to a client which registered the web page.

An information processing method according to still another embodiment of the present invention comprises a detection step of detecting new text inserted in a web page, a conversion step of converting a character string that represents the text into a phonetic character string, and a transmission step of transmitting the phonetic character string to a client which registered the web page.

An information processing method according to still another embodiment of the present invention comprises detection means for detecting new text inserted in a web page, conversion means for converting a character string that represents the text into synthetic speech, and transmission means for transmitting the synthetic speech to a client which registered the web page.

An information processing method according to still another embodiment of the present invention comprises a detection step of detecting new text inserted in a web page a conversion step of converting a character string that represents the text into synthetic speech, and a transmission step of transmitting the synthetic speech to a client which registered the web page.

An information processing method according to still another embodiment of the present invention comprises reception means for receiving a character string that represents new text inserted in a web page, conversion means for converting the character string that represents the text into synthetic speech, and speech output means for outputting the synthetic speech.

An information processing method according to still another embodiment of the present invention comprises a reception step of receiving a character string that represents new text inserted in a web page, a conversion step of converting the character string that represents the text into synthetic speech, and a speech output step of outputting the synthetic speech.

An information processing method according to still another embodiment of the present invention comprises reception means for receiving a phonetic character string that represents new text inserted in a web page, conversion means for converting the phonetic character string that represents the text into synthetic speech, and speech output means for outputting the synthetic speech.

An information processing method according to still another embodiment of the present invention comprises a reception step of receiving a phonetic character string that represents new text inserted in a web page, a conversion step of converting the phonetic character string that represents the text into synthetic speech, and a speech output step of outputting the synthetic speech.

An information processing method according to still another embodiment of the present invention comprises reception means for receiving synthetic speech that represents new text inserted in a web page, and speech output means for outputting the synthetic speech.

An information processing method according to still another embodiment of the present invention comprises a reception step of receiving synthetic speech that represents new text inserted in a web page, and a speech output step of outputting the synthetic speech.

Still other objects of the present invention, and the advantages thereof, will become fully apparent from the following detailed description of the embodiments.

### BRIEF DESCRIPTION OF THE DRAWINGS

FIG. 1 is a block diagram showing an example of a client-server information delivery system according to an embodiment of the present invention;

FIG. 2 is a block diagram showing the arrangement of principal part of a server 10 in the embodiment of the present invention;

FIG. 3 is a view for explaining user information file managed by the server 10;

FIG. 4 is a view for explaining contents information file managed by the server 10;

FIG. 5 is a view for explaining new information file managed by the server 10;

FIG. 6 is a flow chart for explaining the sequence for generating new information file in the embodiment of the present invention;

FIG. 7 is a flow chart for explaining details of the sequence for generating new information file in the embodiment of the present invention;

FIG. 8 is a flow chart for explaining the sequence for delivering delivery information in the embodiment of the present invention;

FIG. 9 is a block diagram showing the arrangement of principal part of a client 20 in the embodiment of the present invention;

FIG. 10 is a flow chart for explaining a principal processing sequence of the client 20 in the embodiment of the present invention;

FIG. 11 is a block diagram showing the arrangement of principal part of a client 21 in the embodiment of the present invention;

FIG. 12 is flow chart for explaining a principal processing sequence of the client 21 in the embodiment of the present invention;

FIG. 13 is a block diagram showing the arrangement of principal part of a client 22 in the embodiment of the present invention;

FIG. 14 is flow chart for explaining a principal processing sequence of the client 22 in the embodiment of the present invention.

### DESCRIPTION OF THE PREFERRED EMBODIMENTS

The preferred embodiments of the present invention will now be described in detail hereinafter with reference to the accompanying drawings.

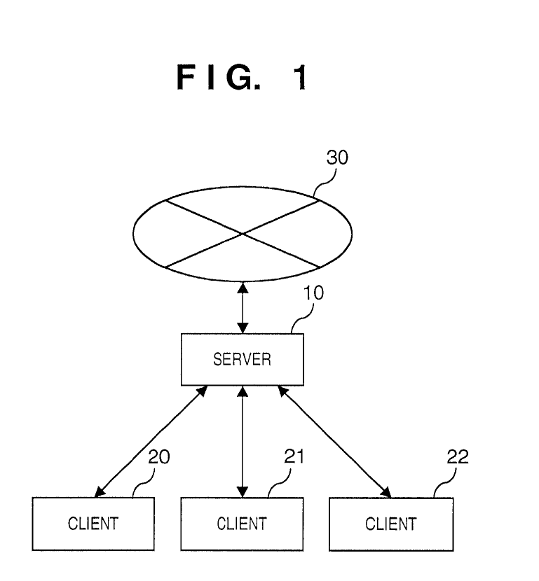

An example of a client-server information delivery system according to this embodiment will be described below with reference to FIG. 1.

Referring to FIG. 1, reference numeral 10 denotes a server. The server 10 detects new text inserted in a web page (to be referred to as new information hereinafter), and delivers it to clients. Reference numerals 20, 21, and 22 denote clients. The clients 20, 21, and 22 receive new information delivered from the server 10, and outputs synthetic speech that represents the new information. Reference numeral 30 denotes the Internet.

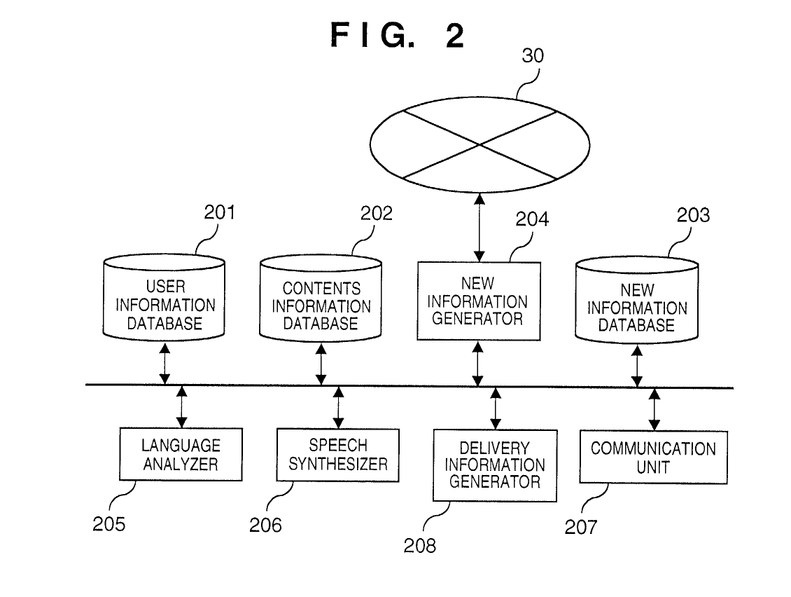

The arrangement of principal part of the server 10 of this embodiment will be described below using FIG. 2.

Referring to FIG. 2, reference numeral 201 denotes a user information database. The user information database 201 manages user information files to be described later. Reference numeral 202 denotes a contents information database. The contents information database 202 manages contents information files to be described later. Reference numeral 203 denotes a new information database. The new information database 203 manages new information files to be described later. Reference numeral 204 denotes a new information generator for generating new information files and contents information files. Reference numeral 205 denotes a language analyzer for converting a character string into a phonetic character string. Note that the language analyzer 205 may be implemented by either hardware or software. Reference numeral 206 denotes a speech synthesizer for converting a phonetic character string into synthetic speech. Note that the speech synthesizer 206 may be implemented by either hardware or software. Reference numeral 207 denotes a communication unit which can communicate with the clients 20, 21, and 22. Reference numeral 208 denotes a delivery information generator for generating delivery information.

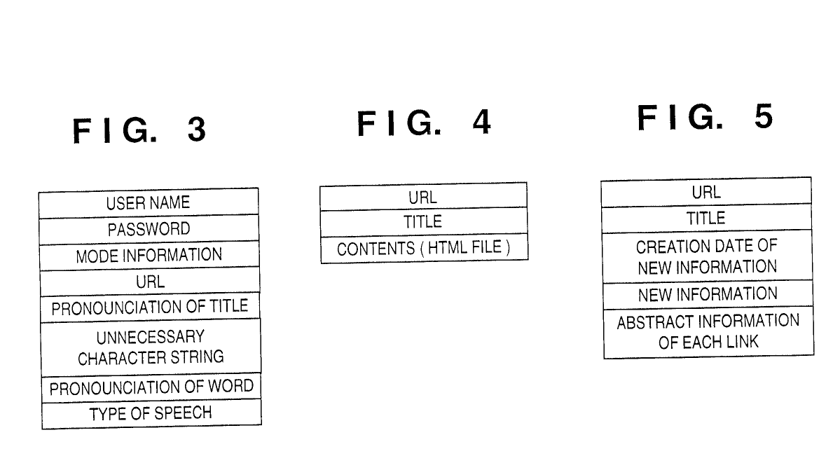

Items to be managed by a user information file in this embodiment will be explained below with reference to FIG. 3. In this embodiment, one user information file manages at least seven items as follows.

(1) User name

This item manages the user name of the client.

(2) Password

This item manages a password registered by the client.

(3) Mode information

This item manages mode information for designating a data format of delivery information to be delivered to the client. If mode information=“1”, the data format of the delivery information is synthetic speech. If mode information=“2”, the data format of delivery information is a phonetic character string. If mode information=“3”, the data format of delivery information is a character string.

(4) URL

This item manages a character string that represents the URL of a web page.

(5) Pronunciation of title

This item manages a character string which represents a pronunciation of the title of a web page.

(6) Unnecessary character string

This item manages a character string which is not to be output as speech (to be referred to as an unnecessary character string hereinafter). One or more unnecessary character strings can be set per URL.

(7) Word and pronunciation of word

This item manages a word to be pronounce as another (e.g., a new word, abbreviation) and a character string that represents a pronunciation of that word. One or more words and their pronunciations can be set per URL.

Items to be managed by a contents information file in this embodiment will be explained below with reference to FIG. 4. In this embodiment, one contents information file manages at least two items as follows.

(1) URL

This item manages a character string which represents the URL of a web page.

(2) Contents

This item stores the latest contents (latest HTML file) of a web page.

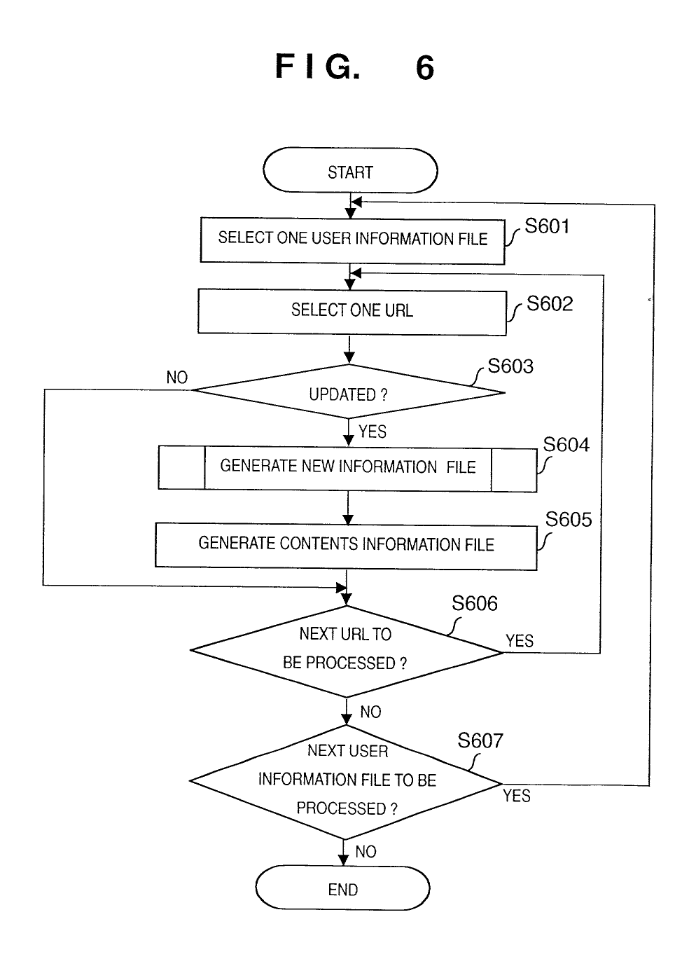

Items to be managed by a new information file in this embodiment will be explained below with reference to FIG. 5. In this embodiment, one new information file manages at least five items as follows.

(1) URL

This item manages a character string that represents the URL of a web page.

(2) Title

This item manages a character string that represents the title of a web page.

(3) Creation date of new information

This item manages a character string which represents year, month, day, and time of creation of new information.

(4) New information

This item manages new text inserted in a web page (i.e., new information).

(5) Abstract information

This item manages a character string that represents an abstract of a web page corresponding to a new link inserted in a web page (to be referred to as abstract information hereinafter). Note that the abstract information is generated in accordance with a predetermined abstract generation program (e.g., a scheme for selecting a sentence including a predetermined keyword).

One of principal processing sequences of the server 10 in this embodiment will be explained below with reference to FIG. 6. FIG. 6 explains the sequence for generating new information files and contents information files in units of URLs registered in each user information file. Note that the server 10 of this embodiment automatically executes the sequence shown in FIG. 6 at a given time interval.

In step S601, the new information generator 204 selects one of user information files stored in the user information database 201.

In step S602, the new information generator 204 selects one of URLs registered in the user information file selected in step S601.

The new information generator 204 checks in step S603 if an HTML file corresponding to the URL selected in step S602 has been updated (i.e., a web page has been updated). If YES in step S603, the flow advances to step S604; otherwise, the flow advances to step S606.

In step S604, the new information generator 204 generates a new information file of the URL selected in step S602, and stores it in the new information database 203.

In step S605, the new information generator 204 generates a contents information file that contains the URL selected in step S602, and the latest HTML file acquired in step S602, and stores it in the contents information database 202.

The new information generator 204 checks in step S606 if the user information file selected in step S601 includes URL to be processed. If YES in step S606, the flow returns to step S602; otherwise, the flow advances to step S607.

The new information generator 204 checks in step S607 if the user information database 201 includes user information files to be processed. If YES in step S607, the flow returns to step S601; otherwise, this flow ends.

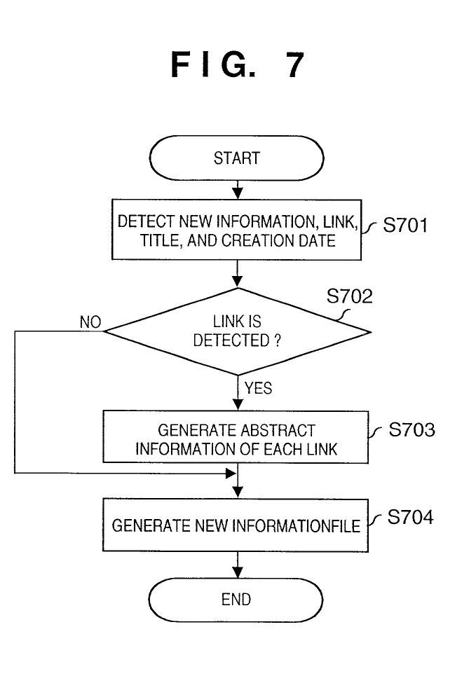

The process in step S604 in FIG. 6 (i.e., the process for generating a new information file) will be described in detail below with reference to FIG. 7.

In step S701, the new information generator 204 detects new text (i.e., new information) and a link inserted in a web page. For example, the new information generator 204 detects the new information and link by comparing the latest HTML file acquired in step S602, and an old HTML file acquired from the contents information file. Furthermore, the new information generator 204 detects the title of the web page and the creation date of the new information.

The new information generator 204 checks in step S702 if a link is detected in step S701. If at least one link is detected, the flow advances to step S703; otherwise, the flow jumps to step S704.

In step S703, the new information generator 204 acquires an HTML file corresponding to each link, and abstracts text described in the acquired HTML file, thus generating abstract information of each link.

In step S704, the new information generator 204 generates a new information file that contains the title, the creation date of the new information, the new information, and the abstract of each link, and stores it in the new information database 203.

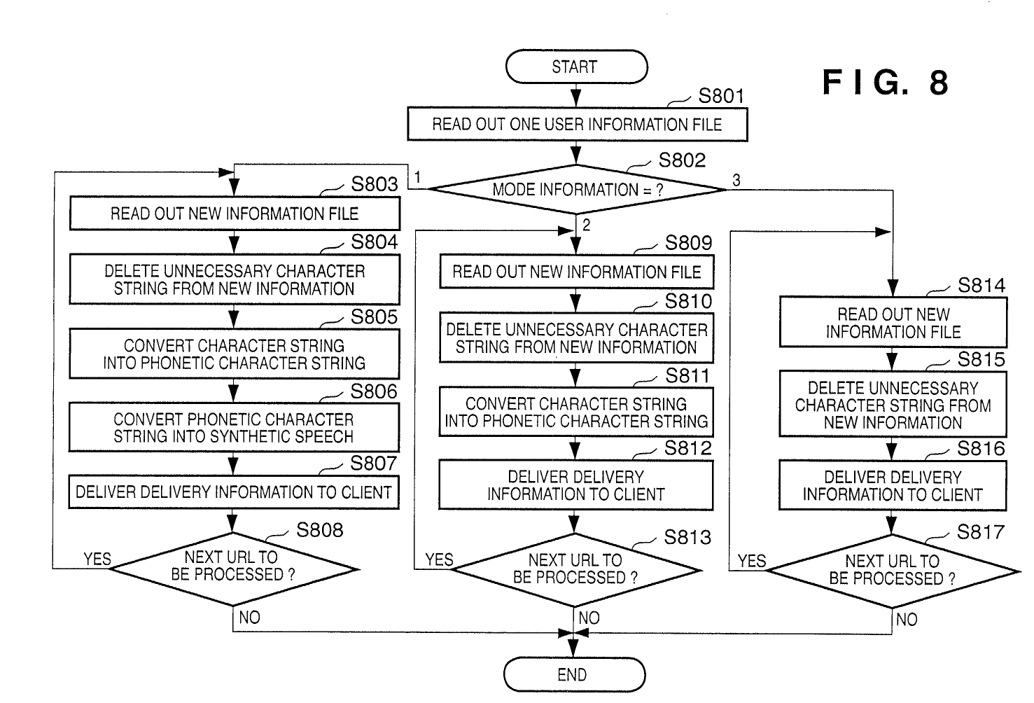

Another principal processing sequence of the server 10 of this embodiment will be described below with reference to FIG. 8. FIG. 8 will explain a sequence for generating delivery information, and delivering that information to the clients.

In step S801, the delivery information generator 208 selects one of user information files stored in the user information database 201.

In step S802, the delivery information generator 208 detects mode information registered in the selected user information file, and discriminates its contents. If mode information=“1”, the flow advances to step S803; if mode information=“2”, the flow advances to step S804; or if mode information=“3”, the flow advances to step S805.

In step S803, the delivery information generator 208 selects one of URLs registered in the selected user information file, and reads out a new information file corresponding to the selected URL from the new information database 203.

In step S804, the delivery information generator 208 deletes unnecessary character strings registered in the user information file from the new information. In the system of this embodiment with this arrangement, character strings the user does not want are inhibited from being spoken. The delivery information generator 208 substitutes a character string that represents the title by that which represents a pronunciation of the title registered in the user information file. In the system of this embodiment with this arrangement, the title of the web page can be spoken in a pronunciation the user wants. Furthermore, the delivery information generator 208 searches the new information for words registered in the user information file, and substitutes the found words by character strings which represent pronunciations of words registered in the user information file. In the system of this embodiment with this arrangement, words the user wants can be spoken in pronunciations of his or her choice.

In step S805, the language analyzer 205 converts character strings which represent the title, the creation date of the new information, the new information, and the abstract information of each link into phonetic character strings (character strings each consisting of characters and symbols that represent pronunciations, accents, pauses, and intonations of words).

In step S806, the speech synthesizer 206 converts the phonetic character strings that represent the title, the creation date of the new information, the new information, and the abstract information of each link into synthetic speeches.

In step S807, the delivery information generator 208 generates delivery information which contains the synthetic speech that represents the title, the creation date of the new information, the new information, and the abstract information of each link. The communication unit 207 delivers the delivery information generated by the delivery information generator 208 to the client 20.

The delivery information generator 208 checks in step S808 if the user information file includes URL to be processed. If YES in step S808, the flow returns to step S803; otherwise, the flow ends.

In step S809, the delivery information generator 208 selects one of URLs registered in the user information file, and reads out a corresponding new information file from the new information database 203.

In step S810, the delivery information generator 208 deletes unnecessary character strings registered in the user information file from the new information. In the system of this embodiment with this arrangement, character strings the user does not want are inhibited from being spoken. The delivery information generator 208 substitutes a character string that represents the title by that which represents a pronunciation of the title registered in the user information file. In the system of this embodiment with this arrangement, the title of the web page can be spoken in a pronunciation the user wants. Furthermore, the delivery information generator 208 searches the new information for words registered in the user information file, and substitutes the found words by character strings which represent pronunciations of words registered in the user information file. In the system of this embodiment with this arrangement, words the user wants can be spoken in pronunciations of his or her choice.

In step S811, the language analyzer 205 converts character strings which represent the title, the creation date of the new information, the new information, and the abstract information of each link into phonetic character strings (character strings each consisting of characters and symbols that represent pronunciations, accents, pauses, and intonations of words).

In step S812, the delivery information generator 208 generates delivery information which contains the phonetic character strings that represent the title, the creation date of the new information, the new information, and the abstract information of each link. The communication unit 207 delivers the delivery information generated by the delivery information generator 208 to the client 21.

The delivery information generator 208 checks in step S813 if the user information file includes URLs to be processed. If YES in step S813, the flow returns to step S809; otherwise, the flow ends.

In step S814, the delivery information generator 208 selects one of URLs registered in the user information file, and reads out a corresponding new information file from the new information database 203.

In step S815, the delivery information generator 208 deletes unnecessary character strings registered in the user information file from the new information.

In step S816, the delivery information generator 208 generates delivery information containing character strings that represent the title, the creation date of the new information, the new information, and the abstract information of each link. The communication unit 207 delivers the delivery information generated by the delivery information generator 208 to the client 22.

The delivery information generator 208 checks in step S817 if the user information file includes URLs to be processed. If YES in step S817, the flow returns to step S814; otherwise, the flow ends.

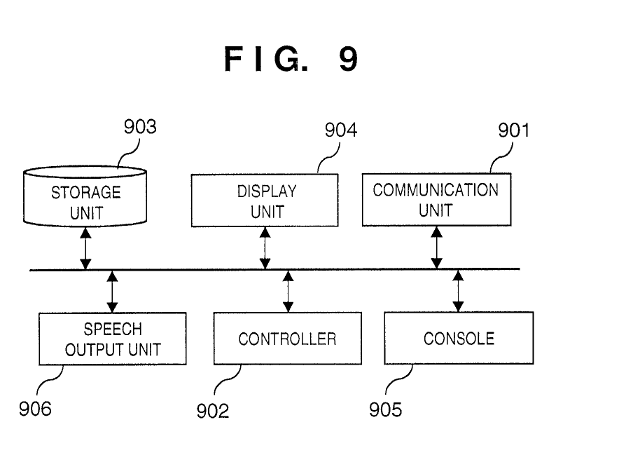

The arrangement of principal part of the client 20 in this embodiment will be described below with reference to FIG. 9. Note that the client 20 can be applied to an information processing apparatus such as a portable telephone, PDA (Personal Digital Assistant), computer, or the like.

Referring to FIG. 9, reference numeral 901 denotes a communication unit which can communicate with the server 10. Reference numeral 902 denotes a controller which comprises a microcomputer and memory. Reference numeral 903 denotes a storage unit which comprises a storage medium such as a hard disk, semiconductor memory, or the like. Reference numeral 904 denotes a display unit which comprises a liquid crystal display. Reference numeral 905 denotes a console which comprises a plurality of operation keys and a microphone. Reference numeral 906 denotes a speech output unit which comprises a speaker.

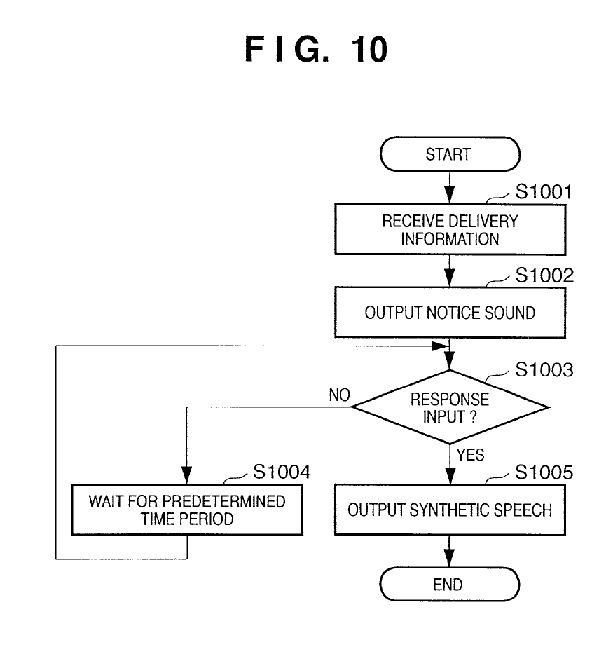

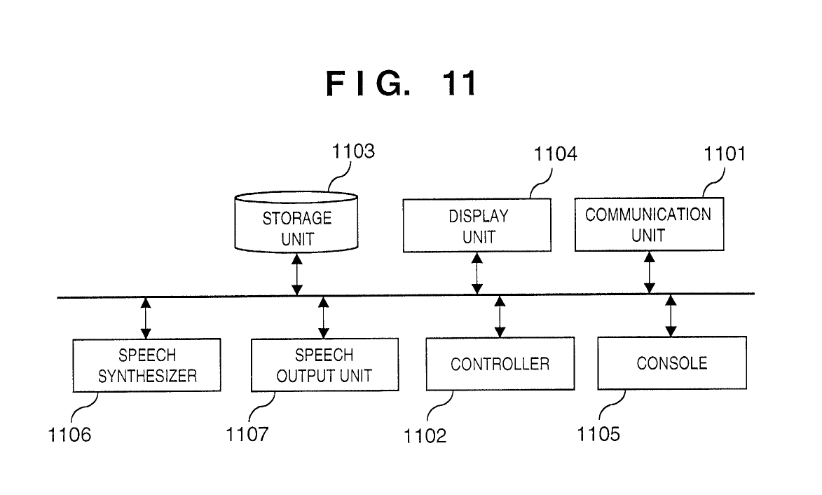

A principal processing sequence of the client 20 in this embodiment will be described below with reference to FIG. 10.

In step S1001, the communication unit 901 receives delivery information delivered from the server 10. The delivery information received by the communication unit 901 is stored in the storage unit 903.

In step S1002, the speech output unit 906 outputs predetermined sound or speech (to be referred to as notice sound hereinafter) N (N is an integer equal to or larger than 1) times, thus calling user's attention.

The controller 902 checks in step S1003 if a response to the notice sound is input before a predetermined period of time elapses from output of the notice sound. The response to the notice sound is input when the user speaks a predetermined word on the microphone of the console 905 or operates a predetermined operation key of the console 905. If no response to the notice sound is input within the predetermined period of time, the flow advances to step S1004. On the other hand, if a response to the notice sound is input within the predetermined period of time, the flow advances to step S1005. With this arrangement, the client 20 can prevent the user from missing the delivery information.

In step S1004, the controller 902 waits until a predetermined period of time (the time period the user set in the client 20 in advance) elapses. After an elapse of the predetermined period of time, the flow returns to step S1003.

In step S1005, the speech output unit 906 reads out the delivery information from the storage unit 903, and sequentially outputs the synthetic speeches which represent the title, the creation date of the new information, the new information, and the abstract information of each link. The user can easily find a web page that has been updated by listening to synthetic speech that represents the title. Also, the user can easily find new information inserted in the web page by listening to synthetic speech that represents the new information. Furthermore, the user can easily find the contents of a new link inserted in the web page by listening to synthetic speech that represents the abstract information of each link.

The arrangement of principal part of the client 21 in this embodiment will be described below with reference to FIG. 11. Note that the client 21 can be applied to an information processing apparatus such as a portable telephone, PDA (Personal Digital Assistant), computer, or the like.

Referring to FIG. 11, reference numeral 1101 denotes a communication unit which can communicate with the server 10. Reference numeral 1102 denotes a controller which comprises a microcomputer and memory. Reference numeral 1103 denotes a storage unit which comprises a storage medium such as a hard disk, semiconductor memory, or the like. Reference numeral 1104 denotes a display unit which comprises a liquid crystal display. Reference numeral 1105 denotes a console which comprises a plurality of operation keys and a microphone. Reference numeral 1106 denotes a speech synthesizer for converting a phonetic character string into synthetic speech. Note that the speech synthesizer 1106 may be implemented by either hardware or software. Reference numeral 1107 denotes a speech output unit which comprises a speaker.

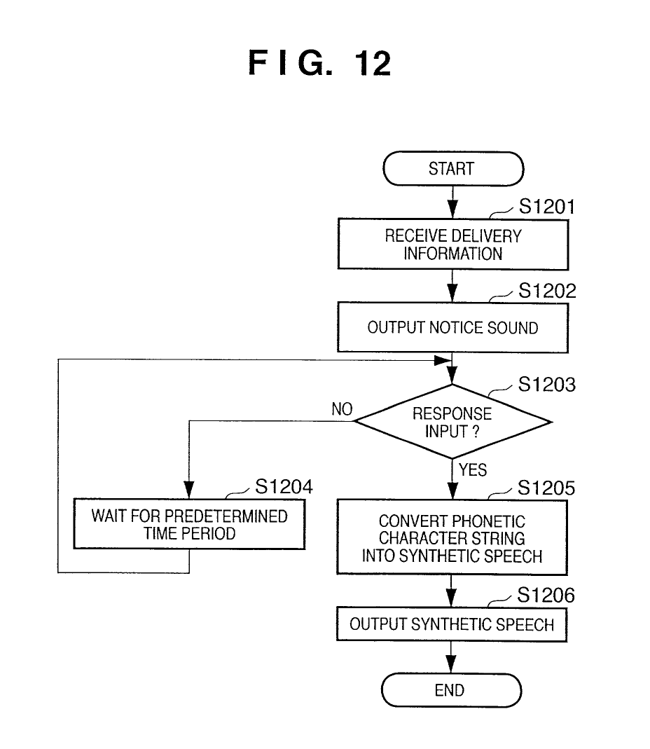

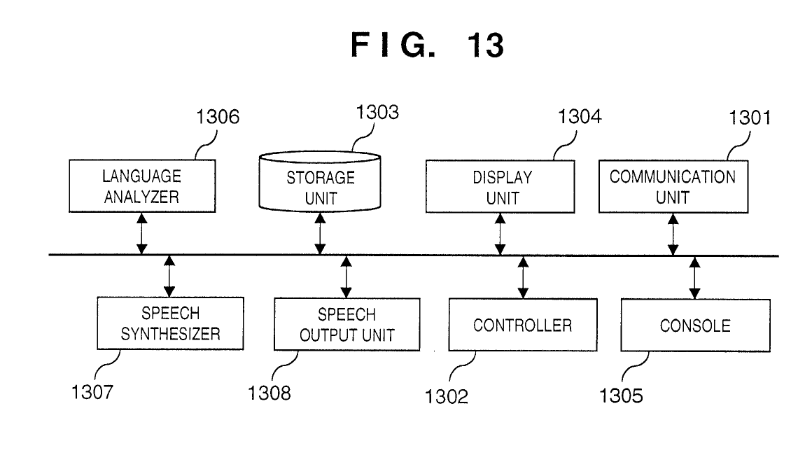

A principal processing sequence of the client 21 in this embodiment will be described below with reference to FIG. 12.

In step S1201, the communication unit 1101 receives delivery information delivered from the server 10. The delivery information received by the communication unit 1101 is stored in the storage unit 1103.

In step S1202, the speech output unit 1106 outputs predetermined sound or speech (to be referred to as notice sound hereinafter) N (N is an integer equal to or larger than 1) times, thus calling user's attention.

The controller 1102 checks in step S1203 if a response to the notice sound is input before a predetermined period of time elapses from output of the notice sound. The response to the notice sound is input when the user speaks a predetermined word on the microphone of the console 1105 or operates a predetermined operation key of the console 1105. If no response to the notice sound is input within the predetermined period of time, the flow advances to step S1204. On the other hand, if a response to the notice sound is input within the predetermined period of time, the flow advances to step S1205. With this arrangement, the client 21 can prevent the user from missing the delivery information.

In step S1204, the controller 1102 waits until a predetermined period of time (the time period the user set in the client 21 in advance) elapses. After an elapse of the predetermined period of time, the flow returns to step S1203.

In step S1205, the speech synthesizer 1106 reads out the delivery information from the storage unit 1103, and converts the phonetic character strings which represent the title, the creation date of the new information, the new information, and the abstract of the each link into synthetic speeches.

In step S1206, the speech output unit 1107 sequentially outputs the synthetic speeches which represent the title, the creation date of the new information, the new information, and the abstract information of each link. The user can easily find a web page that has been updated by listening to synthetic speech that represents the title. Also, the user can easily find new information inserted in the web page by listening to synthetic speech that represents the new information. Furthermore, the user can easily find the contents of a new link inserted in the web page by listening to synthetic speech that represents the abstract information of each link.

The arrangement of principal part of the client 22 in this embodiment will be described below with reference to FIG. 13. Note that the client 22 can be applied to an information processing apparatus such as a portable telephone, PDA (Personal Digital Assistant), computer, or the like.

Referring to FIG. 13, reference numeral 1301 denotes a communication unit which can communicate with the server 10. Reference numeral 1302 denotes a controller which comprises a microcomputer and memory. Reference numeral 1303 denotes a storage unit which comprises a storage medium such as a hard disk, semiconductor memory, or the like. Reference numeral 1304 denotes a display unit which comprises a liquid crystal display. Reference numeral 1305 denotes a console which comprises a plurality of operation keys and a microphone. Reference numeral 1306 denotes a language analyzer for converting a character string into a phonetic character string. Note that the language analyzer 1306 may be implemented by either hardware or software. Reference numeral 1307 denotes a speech synthesizer for converting a phonetic character string into synthetic speech. Note that the speech synthesizer 1307 may be implemented by either hardware or software. Reference numeral 1308 denotes a speech output unit which comprises a speaker.

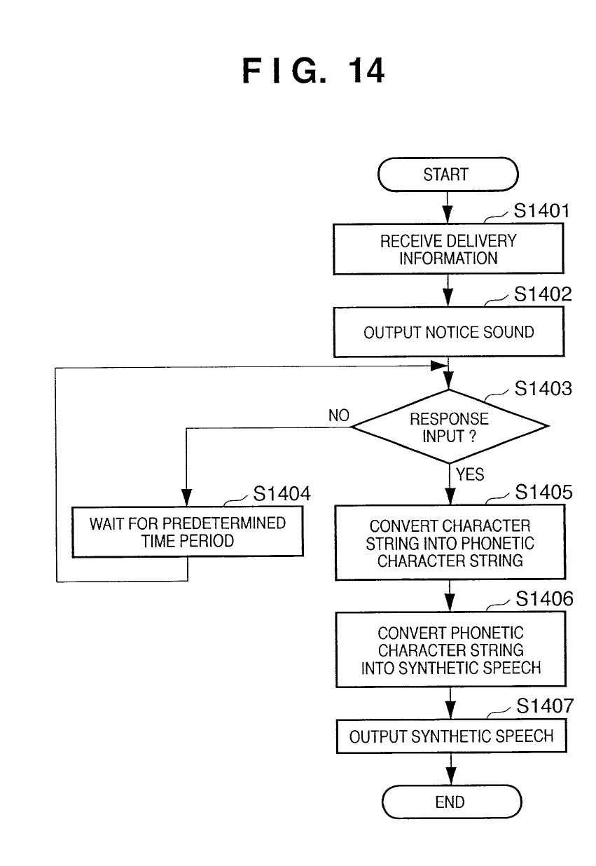

A principal processing sequence of the client 22 in this embodiment will be described below with reference to FIG. 14.

In step S1401, the communication unit 1301 receives delivery information delivered from the server 10. The delivery information received by the communication unit 1301 is stored in the storage unit 1303.

In step S1402, the speech output unit 1306 outputs predetermined sound or speech (to be referred to as notice sound hereinafter) N (N is an integer equal to or larger than 1) times, thus calling user's attention.

The controller 1302 checks in step S1403 if a response to the notice sound is input before a predetermined period of time elapses from output of the notice sound. The response to the notice sound is input when the user speaks a predetermined word on the microphone of the console 1305 or operates a predetermined operation key of the console 1305. If no response to the notice sound is input within the predetermined period of time, the flow advances to step S1404. On the other hand, if a response to the notice sound is input within the predetermined period of time, the flow advances to step S1405. With this arrangement, the client 22 can prevent the user from missing the delivery information.

In step S1404, the controller 1302 waits until a predetermined period of time (the time period the user set in the client 21 in advance) elapses. After an elapse of the predetermined period of time, the flow returns to step S1403.

In step S1405, the language analyzer 1306 reads out the delivery information from the storage unit 1303, and converts character strings which represent the title, the creation date of the new information, the new information, and the abstract of the each link into phonetic character strings.

In step S1406, the speech synthesizer 1307 converts the phonetic character strings which represent the title, the creation date of the new information, the new information, and the abstract of the each link into synthetic speeches.

In step S1407, the speech output unit 1308 sequentially outputs the synthetic speeches which represent the title, the creation date of the new information, the new information, and the abstract information of each link. The user can easily find a web page that has been updated by listening to synthetic speech that represents the title. Also, the user can easily find new information inserted in the web page by listening to synthetic speech that represents the new information. Furthermore, the user can easily find the contents of a new link inserted in the web page by listening to synthetic speech that represents the abstract information of each link.

As described above, according to this embodiment, the client 20 can briefly inform the user of the latest information inserted in a desired web page by registering the URL of the desired web page in the server 10.

Also, according to this embodiment, since the data format of new information to be delivered to the client 20 and the like can be changed in correspondence with the functions of the client 20 and the like, a system which can flexibly cope with clients having different functions can be built.

The invention may be embodied in other specific forms without departing from essential characteristics thereof.

Therefore, the above-mentioned embodiments are merely examples in all respects, and must not be construed to limit the invention.

The scope of the present invention is defined by the scope of the appended claims, and is not limited at all by the specific descriptions of this specification. Furthermore, all the modifications and changes belonging to equivalents of the claims are considered to fall within the scope of the present invention.

What is claimed is:

1. An information processing apparatus comprising:
detection means for detecting new text inserted in a web page; and
transmission means for transmitting a character string that represents the text to a client which registered the web page.

2. The apparatus according to claim 1, wherein said transmission means transmits to the client a character string corresponding to a title of the web page together with the character string that represents the text.

3. The apparatus according to claim 1, wherein said transmission means transmits to the client a character string corresponding to a creation date of the text together with the character string that represents the text.

4. The apparatus according to claim 1, further comprising:
means for deleting a predetermined character string from the character string that represents the text.

5. An information processing method comprising:
a detection step of detecting new text inserted in a web page; and
a transmission step of transmitting a character string that represents the text to a client which registered the web page.

6. The method according to claim 5, wherein said transmission step includes a step of transmitting to the client a character string corresponding to a title of the web page together with the character string that represents the text.

7. The method according to claim 5, wherein said transmission step includes a step of transmitting to the client a character string corresponding to a creation date of the text together with the character string that represents the text.

8. The method according to claim 5, further comprising:
a step of deleting a predetermined character string from the character string that represents the text.

9. An information processing apparatus comprising:
detection means for detecting new text inserted in a web page;
conversion means for converting a character string that represents the text into a phonetic character string; and
transmission means for transmitting the phonetic character string to a client which registered the web page.

10. The apparatus according to claim 9, wherein said transmission means transmits to the client a phonetic character string corresponding to a title of the web page together with the phonetic character string that represents the text.

11. The apparatus according to claim 9, wherein said transmission means transmits to the client a character string corresponding to a creation date of the text together with the character string that represents the text.

12. The apparatus according to claim 9, further comprising:
means for deleting a predetermined character string from the character string that represents the text.

13. An information processing method comprising:
a detection step of detecting new text inserted in a web page;
a conversion step of converting a character string that represents the text into a phonetic character string; and
a transmission step of transmitting the phonetic character string to a client which registered the web page.

14. The method according to claim 13, wherein said transmission step includes a step of transmitting to the client a phonetic character string corresponding to a title of the web page together with the phonetic character string that represents the text.

15. The method according to claim 13, wherein said the transmission step includes a step of transmitting to the client a character string corresponding to a creation date of the text together with the character string that represents the text.

16. The method according to claim 13, further comprising:
a step of deleting a predetermined character string from the character string that represents the text.

17. An information processing apparatus comprising:
detection means for detecting new text inserted in a web page;
conversion means for converting a character string that represents the text into synthetic speech; and
transmission means for transmitting the synthetic speech to a client which registered the web page.

18. The apparatus according to claim 17, wherein said transmission means transmits to the client synthetic speech corresponding to a title of the web page together with the synthetic speech corresponding to the text.

19. The apparatus according to claim 17, wherein said transmission means transmits to the client synthetic speech corresponding to a creation date of the text together with the synthetic speech corresponding to the text.

20. The apparatus according to claim 17, further comprising:
means for deleting a predetermined character string from the character string that represents the text.

21. An information processing method comprising:
a detection step of detecting new text inserted in a web page;
a conversion step of converting a character string that represents the text into synthetic speech; and
a transmission step of transmitting the synthetic speech to a client which registered the web page.

22. The method according to claim 21, wherein said transmission step includes a step of transmitting to the client synthetic speech corresponding to a title of the web page together with the synthetic speech corresponding to the text.

23. The method according to claim 21, wherein said transmission step includes a step of transmitting to the client synthetic speech corresponding to a creation date of the text together with the synthetic speech corresponding to the text.

24. The method according to claim 21, further comprising:
a step of deleting a predetermined character string from the character string that represents the text.

25. An information processing apparatus comprising:
reception means for receiving a character string that represents new text inserted in a web page;
conversion means for converting the character string that represents the text into synthetic speech; and
speech output means for outputting the synthetic speech.

26. The apparatus according to claim 25, wherein said reception means receives a character string corresponding to a title of the web page together with the character string that represents the text.

27. The apparatus according to claim 25, wherein said reception means receives a character string corresponding to a creation date of the text together with the character string that represents the text.

28. The apparatus according to claim 25, wherein said speech output means outputs predetermined sound or speech before outputting the synthetic speech.

29. The apparatus according to claim 25, wherein said information processing apparatus is one of a portable telephone, PDA, and computer.

30. An information processing method comprising:
a reception step of receiving a character string that represents new text inserted in a web page;
a conversion step of converting the character string that represents the text into synthetic speech; and
a speech output step of outputting the synthetic speech.

31. The method according to claim 30, wherein said reception step includes a step of receiving a character string corresponding to a title of the web page together with the character string that represents the text.

32. The method according to claim 30, wherein said reception step includes a step of receiving a character string corresponding to a creation date of the text together with the character string that represents the text.

33. The method according to claim 30, wherein said speech output step includes a step of outputting predetermined sound or speech before outputting the synthetic speech.

34. An information processing apparatus comprising:
reception means for receiving a phonetic character string that represents new text inserted in a web page;
conversion means for converting the phonetic character string that represents the text into synthetic speech; and
speech output means for outputting the synthetic speech.

35. The apparatus according to claim 34, wherein said reception means receives a phonetic character string corresponding to a title of the web page together with the phonetic character string that represents the text.

36. The apparatus according to claim 34, wherein said reception means receives a phonetic character string corresponding to a creation date of the text together with the phonetic character string that represents the text.

37. The apparatus according to claim 34, wherein said speech output means outputs predetermined sound or speech before outputting the synthetic speech.

38. The apparatus according to claim 34, wherein said information processing apparatus is one of a portable telephone, PDA, and computer.

39. An information processing method comprising:
a reception step of receiving a phonetic character string that represents new text inserted in a web page;
a conversion step of converting the phonetic character string that represents the text into synthetic speech; and
a speech output step of outputting the synthetic speech.

40. The method according to claim 39, wherein said reception step includes a step of receiving a phonetic character string corresponding to a title of the web page together with the phonetic character string that represents the text.

41. The method according to claim 39, wherein said reception step includes a step of receiving a phonetic character string corresponding to a creation date of the text together with the phonetic character string that represents the text.

42. The method according to claim 39, wherein said speech output step includes a step of outputting predetermined sound or speech before outputting the synthetic speech.

43. An information processing apparatus comprising:
reception means for receiving synthetic speech that represents new text inserted in a web page; and
speech output means for outputting the synthetic speech.

44. The apparatus according to claim 43, wherein said reception means receives synthetic speech corresponding to a title of the web page together with the synthetic speech corresponding to the text.

45. The apparatus according to claim 43, wherein said reception means receives synthetic speech corresponding to a creation date of the text together with synthetic speech corresponding to the text.

46. The apparatus according to claim 43, wherein said speech output means outputs predetermined sound or speech before outputting the synthetic speech.

47. The apparatus according to claim 43, wherein said information processing apparatus is one of a portable telephone, PDA, and computer.

48. An information processing method comprising:
a reception step of receiving synthetic speech that represents new text inserted in a web page; and
a speech output step of outputting the synthetic speech.

49. The method according to claim 48, wherein said reception step includes a step of receiving synthetic speech corresponding to a title of the web page together with the synthetic speech corresponding to the text.

50. The method according to claim 48, wherein said reception step includes a step of receiving synthetic speech corresponding to a creation date of the text together with the synthetic speech corresponding to the text.

51. The method according to claim 48, wherein said speech output step includes a step of outputting predetermined sound or speech before outputting the synthetic speech.
